(19) United States
(12) Patent Application Publication
(10) Pub. No.: US 2023/0080477 A1
(43) Pub. Date: Mar. 16, 2023

(54) PROCESS OF SYNTHESIS OF NOVEL CHROMIUM (III) COMPLEXES OF SCHIFF BASE LIGANDS AND THEIR USE THERE OF AS THERAPEUTIC AGENTS

(71) Applicant: RICHA KOTHARI, Gwalior (IN)

(72) Inventor: RICHA KOTHARI, Gwalior (IN)

(21) Appl. No.: 17/838,642

(22) Filed: Jun. 13, 2022

(30) Foreign Application Priority Data
Sep. 6, 2021 (IN) 202121040302

(51) Int. Cl. C07F 11/00

(52) U.S. Cl. CPC C07F 11/00; C07B 2200/13

(57) ABSTRACT

Chromium (III) Complexes of the following Schiff base ligands derived from N-[4-methyl phenyl-3-oxo-3-[2-1H-Pyrrole-3yl hyrazinyl] propanamide and cinnamaldehyde were synthesized. Schiff base Ligands and their coordinated chromium (III) complexes were characterized using elemental analysis, UV-Vis, FT-IR, conductance data, TEM, XRD, and thermogravimetric analysis. In the UV-VIS study, a bathochromic shift of approximately 80 nm indicates the formation of chromium(III) complex by more than one coordinating site. The FT-IR spectra of complexes clearly show that the formation of Cr—N bond between ligand and Cr(III) ion at 1680 cm⁻¹, while the TGA analysis shows the presence of six coordinated water molecules in the complex. Based on the physicochemical analysis, the following empirical formula has been assigned to chromium (III) complexes: [Cr(C₂₉H₃₃N₁₇S₂)]Cl₃.6H₂O and [Cr(C₃₅H₃₆Cl₂N₆O₄)]Cl₃.6H2O. Moreover, the antioxidant activity of complexes was evaluated by using 2,2′-diphenyl-1-picrylhydrazyl(DPPH) free radical assay which showed that the complexes have a higher antioxidant activity than that of Schiff base ligands.

### FIELD OF THE INVENTION

The present invention relates to enhancing bio efficacy of drug and in particular the present invention relates to Process of Synthesis of Novel Chromium (III) complexes of Schiff Base ligands and their use there of as Therapeutic Agents

### BACKGROUND OF THE INVENTION

Schiff bases are unique compounds having a C═N functional group, sometimes this bond referred to as an azomethine bond and possess the general formula R1 R2 C═NR3 (R3 not equal to H). Schiff bases are produced by condensing primary amines and carbonyl compounds (aldehyde & ketones). Ligands containing aryl substituents are easily synthesized as compared to alkyl substituents because schiff bases synthesized from aliphatic aldehydes are very unstable and undergoes polymerization process easily. In synthesis of schiff base ligands, the condensation process usually occurs in the presence of acid and base or by heating and easily goes to completion either by removal of water molecules or by removal of other small molecules like ammonia. Formation of schiff bases are reversible process and they are reversibly hydrolyzed into their hydrolyzing components amine and carbonyl compounds by using acid, base or water.

The acid catalyzed reactions of schiff base formation involves the nucleophilic addition reaction mechanism via the nucleophilic attack of the primary amine on the carbonyl center to give an unstable intermediate compound, carbinolamine. On acid catalyzed dehydration of carbinolamine intermediate compound results in the formation of N-substituted imine or schiff base. Literature revealed that the coordination chemistry of schiff bases has been considerably enriched due to the synthesis of transition metal complexes through heteroatoms like N, O or S atom which makes them biologically active excellent chelators of metal ions. Schiff bases and their metal complexes have various applications in synthetic organic chemistry as an intermediates and as catalysts.[1-3]. Metal complexes of schiff base ligands also make important contributions to pharmaceuticals [4-5] and their industrial applications includes foods, dyes and polymers [1,2,6]. Schiff base coordination compounds have various pharmaceutical applications because they show antibacterial, antifungal, antimalarial, antiviral and anticancer activities, which are often enhance when they are in metal complex form[1,7,10]. They have also been reported as effective corrosion inhibitors on mild steel such as copper and aluminum (Solmaz et al., 2011). Due to the presence of phenolic —OH group, schiff bases are reported as powerful antioxidants and good radical scavengers(Mohammed et al., 2012). Metal complexes of schiff bases also show reported as powerful antioxidant agents because they have a high capacity for scavenging free radicals [10-13]. Free radicals are implicated as a major factor in the development of oxidative damage diseases (e.g. atherosclerosis, cancer, liver cirrhosis, diabetes, cardiovascular and neurodegenerative diseases) and in ageing [14-16] which can be promoted by cigarette smoke, drugs and pollution.

As a consequence, there is an important need for antioxidants as a defense against free radical attack. The continuous interest of researchers towards the schiff base chemistry of metal complexes have developed a new effective therapeutic agents for the treatment of several infections like antibacterial, antifungal, antiviral etc. Chromium is a unique toxic element present in two oxidant states i.e. Cr(III) & Cr (VI), the latter being more toxic. Cr (III) is the most stable under acidic conditions but it is readily oxidized to Cr(VI) in alkaline solution. Cr(III) usually forms a very stable type of octahedral complexes with six coordination numbers. This stability comes from its d3 electronic configuration, which affords a high crystal field stabilization energy (CFSE) value. Cr(VI) compounds show carcinogenicity and corrosion to tissues as well as toxicity to plants, animals, and bacteria.

In human's chromium affect the liver, kidneys and cause gastric damage and lung cancer. Chromium supplementation is highly useful for weight gain in protein energy malnutrition (PEM) states (Khade et al., 2011). Trivalent chromium is considered as an essential trace element. Its higher concentration in the body may be regarded as toxic. Cr(III) ion has an important role in maintaining the normal glucose tolerance by regulating the action of insulin (Krejpcio,2001)18. Due to its specific transport mechanism, limited amounts may penetrate the cells. But higher concentrations in the ells may lead to DNA damage. Acute toxicity may appear in the range of 1.5-3.3 mg/kg. (Eastmond et al., 2008; Katz & salem, 1993)19. In such a case, it becomes necessary to reduce the metal content in the body using strong complexing agents (Tian et al. 2006)20 such as Schiff base in the transport process of chromium.

Thus, the interaction of Schiff base ligands with Cr (III) may prove to be of biochemical and biological importance. In order to reduce the metal-induced toxicity chalation therapy is the ideal method, where chelating agent (like Schiff base ligands) may bind the toxic or excess metal ions strongly by forming complex structure that may be easily excreted from the body (Dehghan & Khoshkam 2012)21. Similarly, chromium may be excreted from the body mainly in urine as well as in sweat, hair and bile in minute amounts but, after absorption, faecal excretion is consider as the main route. Hence, urinary excretion act as the main elimination route (Krejpcio, 2001). Thus, schiff base ligand (as chelating agent) can play a major role in bioavailability of essential metals as well as in metal detoxification of toxic metal ions (Dehghan & Khoshkam,2012) 21.

The complexing reactions of schiff base ligands with chromium (III) ions from a variety of samples. (Kuntic et al, 2000)22. Hence the formation of chromium—Schiff base complexes may be useful in the colorimetric determination of metal ions, like Cr (III) from food and water samples. Apart from this Chromium (III) complexes of schiff bases may be useful in the identification, determination and quantification of biological molecules from the nectar of honey, waste tobacco leaves (Fathiazad et al., 2006)23 beverage food, drugs, cosmetics, etc. (Kuntic et al., 1998)24.

The chromium complexes of schiff base can have many biological as well as industrial applications. These acts as highly reactive antioxidant agent than parent schiff base ligand. Chromium (III) complexes produced dark colored complexes, which can be useful for the textile and dye industries. Chromium compound can also be used for cosmetic purpose due to their having no side effects.

### OBJECTIVES OF THE INVENTION

The main object of the present invention is to provide a novel and therapeutically effective antioxidant drug with proven pharmacological activities and it's processing for the synthesis of drug with synergistic effect. The present invention relates to the use of a bio-availability and/or bio-efficacy and methods of their preparation which includes their synthesis and obtaining the final products in their chemically characterized form.

Another object of the Present invention is to provide a new approach of increasing the bio efficacy of drug had been conceptualized.

Another object of the Present invention is to provide synthesis of Schiff base ligands.

Another object of the Present invention is to provide synthesis of Chromium(III) complexes from Schiff base ligands.

Another object of the Present invention is to provide physicochemical Characterization of synthesized ligands & their Chromium(III) Complexes via UV-Vis, FT-IR,XRD,TEM,TGA, Elemental analysis, molar conductance.

Another object of the Present invention is to provide evaluation of Antioxidant activities of Schiff base ligands & their Chromium(III) Complexes.

### SUMMARY OF THE INVENTION

Chromium (III) Complexes of the following Schiff base ligands derived from N-[4-methyl phenyl-3-oxo-3-[2-1H-Pyrrole-3yl hyrazinyl] propanamide and cinnamaldehyde were synthesized. Schiff base Ligands and their coordinated chromium (III) complexes were characterized using elemental analysis, UV-Vis, FT-IR, conductance data, TEM, XRD, and thermogravimetric analysis. In the UV-VIS study, a bathochromic shift of approximately 80 nm indicates the formation of chromium(III) complex by more than one coordinating site. The FT-IR spectra of complexes clearly show that the formation of Cr—N bond between ligand and Cr(III) ion at 1680 cm−1, while the TGA analysis shows the presence of six coordinated water molecules in the complex.

Based on the physicochemical analysis, the following empirical formula has been assigned to chromium (III) complexes: [Cr(C29H33N17S2)]Cl3.6H2O and [Cr(C35H36Cl2N6O4)]Cl3.6H2O. Moreover, the antioxidant activity of complexes was evaluated by using 2,2′-diphenyl-1-picrylhydrazyl(DPPH) free radical assay which showed that the complexes have a higher antioxidant activity than that of Schiff base ligands.

In accordance with an embodiment of the present invention, a process of preparation of synthesis of novel metal complexes from Schiff base ligands is provided. The process comprising steps of preparing a schiff base ligands of a predetermined quantities of primary amines with a predetermined quantity of aldehydes thereby forming a precipitate, wherein the alcohol precipitate is adapted to crystalline structure. Further, preparing a solution of primary amines and Schiff base ligands in alcohol and dropping the alcoholic solution of metallic salt in the form of droplets in the solution of alcohol thereby forming a colored precipitate. Furthermore, soaking the precipitate into the solution of alcohol for a predetermined time period and separating a precipitate using a filter and drying the precipitate for a determined time period thereby forming the crystalline precipitate of metal complexes.

Preferably, the metal complexes are stable at ambient temperature and reduce the impact of moisture on the environment and reduce the contamination of the water of crystallization.

Preferably, the compounds are soluble in nonpolar solvents according to acceptance of solubility rule thereby protecting degradation or loss of compounds in solubility process.

Preferably, the compounds are better scavengers of superoxide anion radicals than precursors.

Preferably, the precursors and metal ions are present in 2:2:1 molar ratio.

### BRIEF DESCRIPTION OF THE DRAWINGS

So that the manner in which the above recited features of the present invention can be understood in detail, a more particular to the description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments.

These and other features, benefits and advantages of the present invention will become apparent by reference to the following text figure, with like reference numbers referring to like structures across the views, wherein:

FIG. 1 illustrates synthesis of Ester (Precursor-1);

FIG. 2 illustrates synthesis of acid hydrazide (Precursor-2);

FIG. 3 illustrates synthesis of Schiff base ligands;

FIG. 4 illustrates synthesis of Chromium (III) Complexes;

FIG. 5 illustrates FT-IR Spectra of Coordinated Chromium (III) Complex of Schiff base ligand 1;

FIG. 6 illustrates FT-IR Spectra of Chromium (III) Complex of Schiff base ligand 2;

FIG. 7 illustrates UV-Visible spectra of Chromium (III) Complex of Schiff base ligand 1;

FIG. 8 illustrates UV-Visible spectra of Chromium (III) Complex of Schiff base ligand 2;

FIG. 9 illustrates TGA graph of Coordinated Chromium (III) Complex;

FIG. 10 illustrates XRD spectra chromium (III) complex of Schiff base Ligand 1;

FIG. 11 illustrates XRD spectra chromium (III) complex of Schiff base Ligand 2;

FIG. 12 illustrates TEM images of Chromium(III) complex of Schiff base Ligand-1,

FIG. 13 illustrates TEM images of Chromium(III) complex of Schiff base Ligand 2;

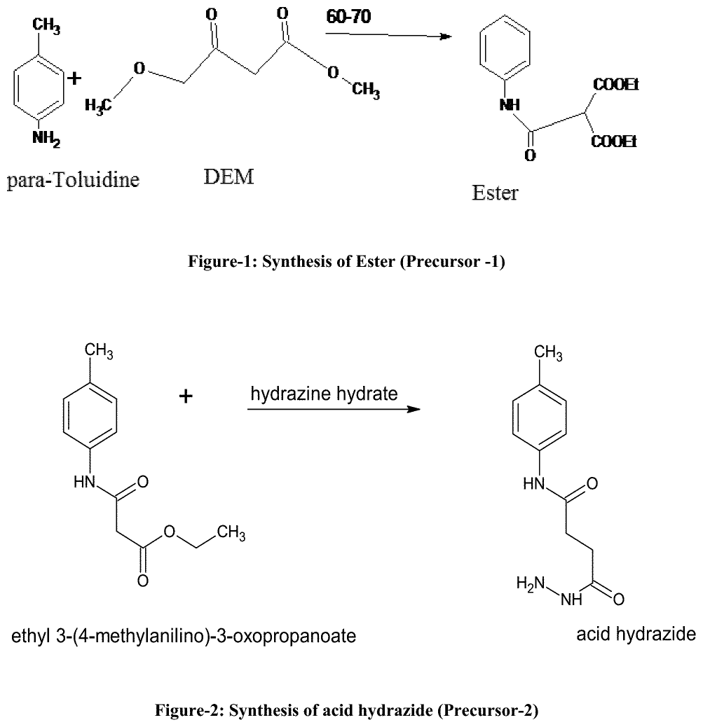

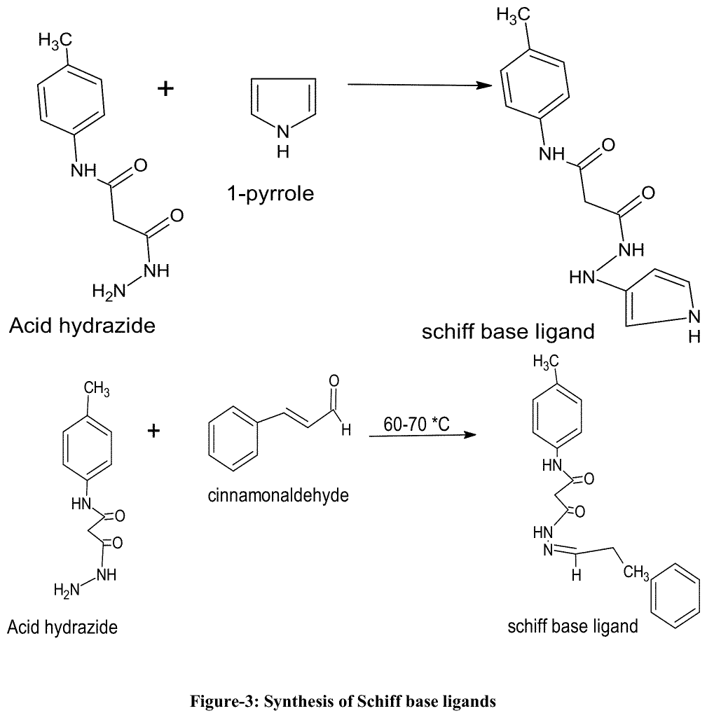

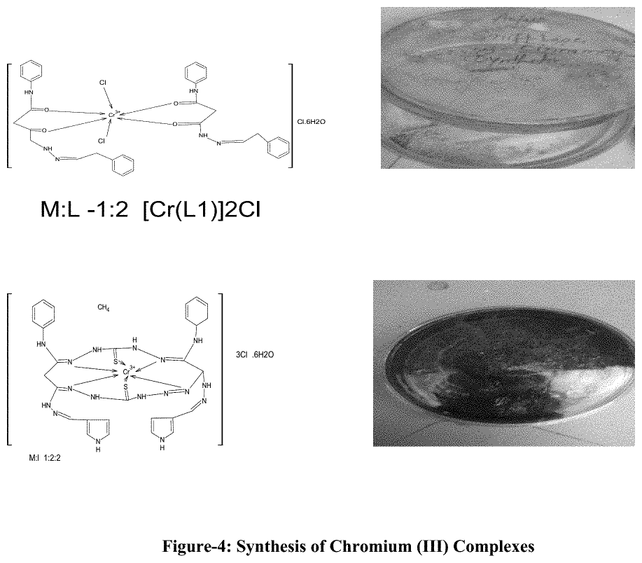

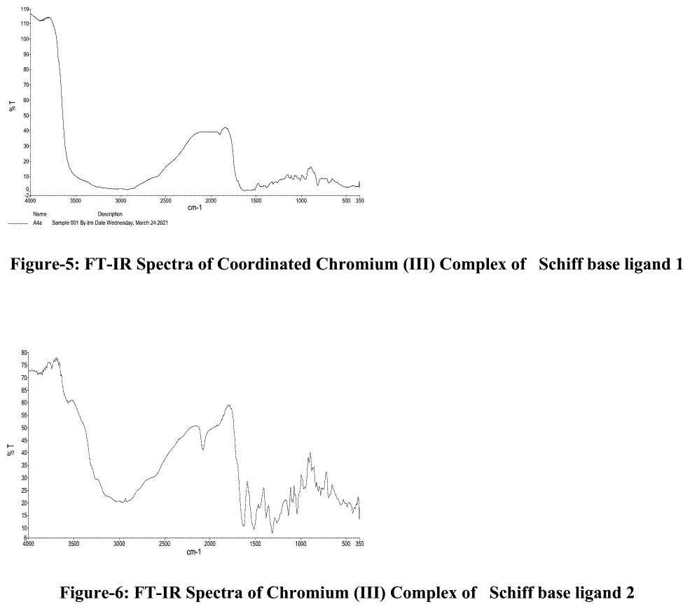

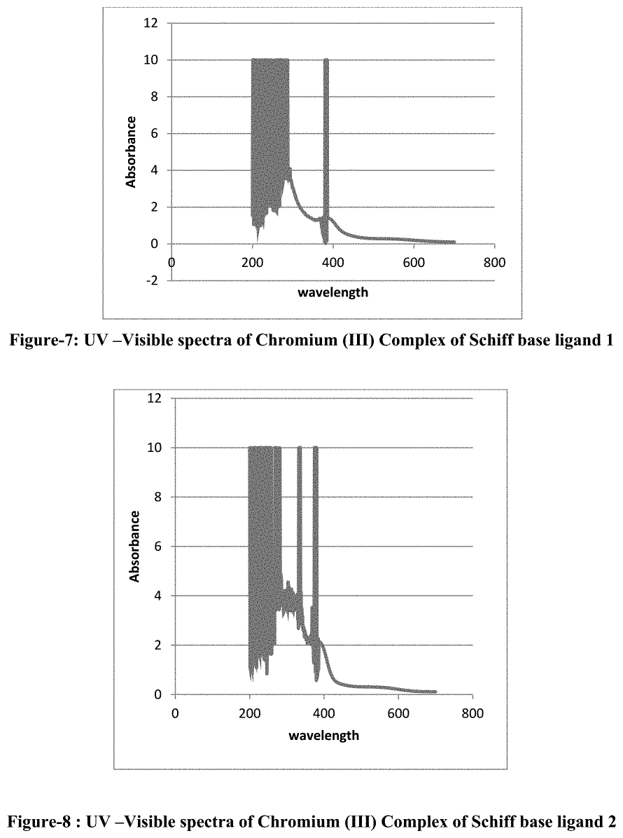

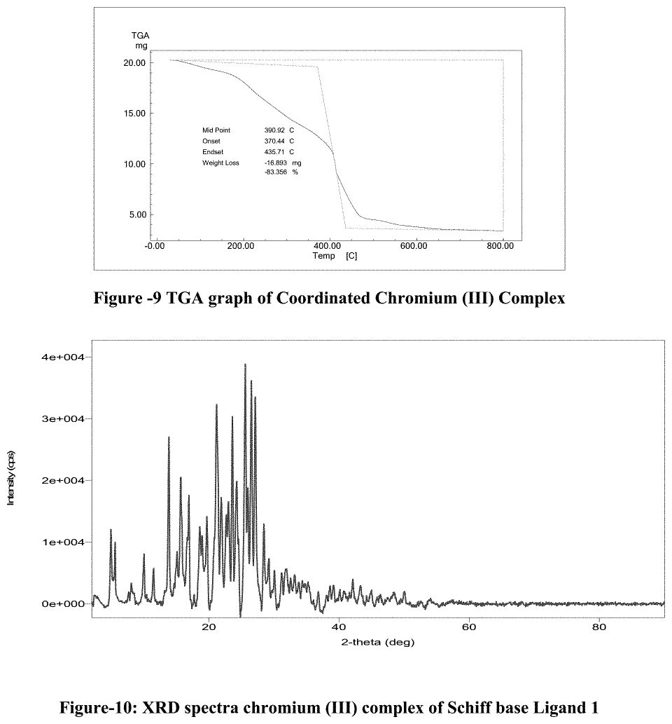

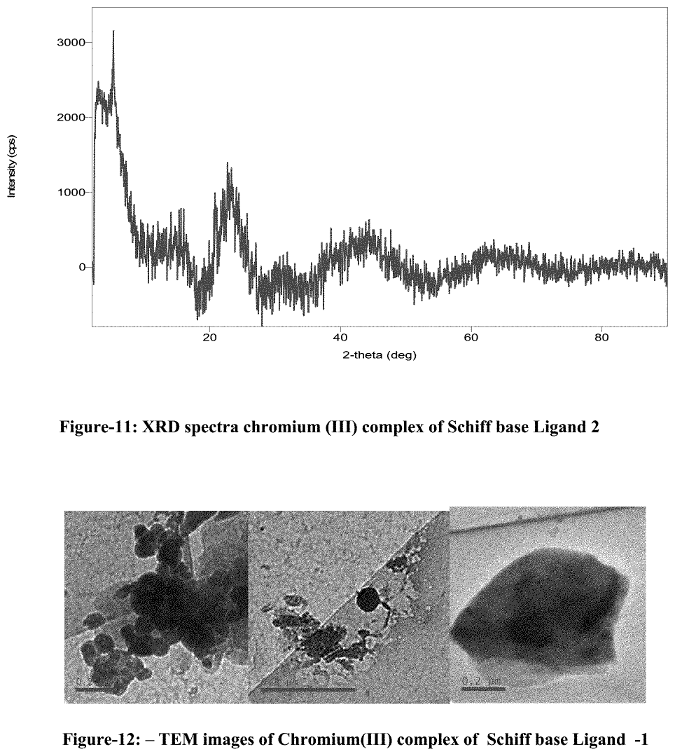

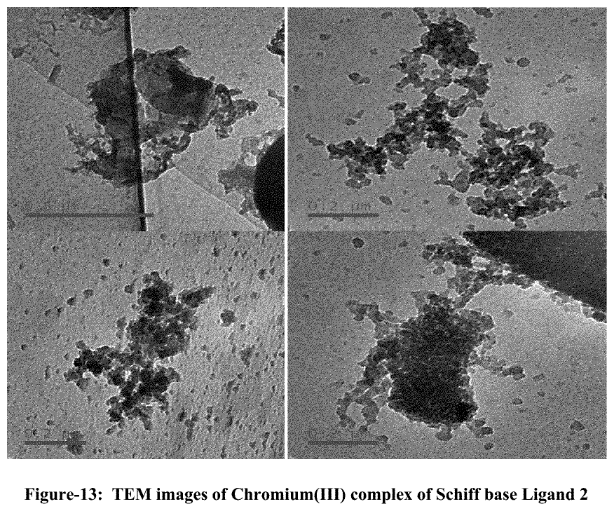

### DETAILED DESCRIPTION OF THE DRAWINGS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles, and the like are included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of,”“including”, or “is” preceding the recitation of the composition, element or group of elements and vice versa.

The present invention is described hereinafter by various embodiments with reference to the accompanying drawings, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

### Experimental

All the reagents and solvents were of analytical grade or chemically pure. Diethyl malonate, p-Toluidine, Hydrazine hydrate, Pyrrol-2-carboxaldehyde, and 2,2′-diphenyl-1-picrylhydrazyl radical (DPPH) were purchased from sigma-Aldrich (USA). Chromium (III) chloride, thiosemicarbazide hydrochloride salts were purchased from Merck (Germany). HPLC-grade quality methanol was obtained from Fisher Scientific (UK), KBr from Aldrich chemical (Germany). All the reagents were weighed within an accuracy of ±0.1 mg. UV-Vis spectra were obtained using a Perkin Elmer UV-VIS Lambda 25 spectrophotometer in the range of 200-900 nm using standard 1.00 cm quartz cells. FT-IR spectra were recorded in the spectral range of 4000-400 cm−1 on a Parkin Elmer 2400 FTIR spectrophotometer using KBr pellets. 1HNMR spectrum was recorded on a BRUKER ADVANCED NEO 500 MHz spectrometer in DMSO using TMS as an internal standard. Chemical Shifts are given in δ relative to TMS. Thermogravimetric differential thermal analysis (TG-DTA) curves were obtained on a TGA (PCT-2A) Thermo balance analyzer under a nitrogen atmosphere at heating rate of 100 C. min−1from ambient to 8000 C. The Chromium (III) complexes of the Schiff base ligand remained stable up to 3000 C. In this paper, we have synthesized, characterized, and tested the antioxidant properties of two Chromium (III) complexes of Schiff base ligands derived from Pyyrol-2-Carboxyldehyde and Cinnamaldehyde. The resultant Schiff base ligands are N-[4-methyl phenyl-3-oxo-3-[2-1H-pyrrol-3yl hydrazinyl]propanamide(L1) and N-[4-methyl phenyl)-3-oxo-3[(2Z)-2-propylidene hydrazinyl] propanamide through condensation with thiosemicarbazide hydrochloride (L2).

### 2.1 Synthesis of Ester (Precursor-1)

An equimolar amount of primary amine and Diethylmalonate in 1:2 taken in a two neck 250 ml RB flask and attach with condenser (19/20)″ neck. Heat the mixture for 30 minutes, cool the solution, and solidifies. Now add about 30 ml of alcohol to the solid substance and stirred the solution mechanically until the solid material is broken down to crystalline material. Now pour this solution into 100 g. of ice with constant stirring. Filter the solution and recrystallized the precipitate from absolute ethanol.

### 2.2 Synthesis of Acid Hydrazide (Precursor-2)

Add Aequimolar amount of precursor 1 (2 gm) and 20 ml of Hydrazine hydrate in a round bottom flask and stirrer the mixture for about 2 hrs at room temperature. After aging of 24 hours white shinny solid precipitate appears.

### 2.3 Synthesis of Schiff Base Ligands

Pyrrol-2-carboxaldehyde (1.24 g, 10 mmol) was added to a two-necked round-bottomed flask containing 20 ml ethanol followed by the addition of substituted aromatic amine (0.76 g (10 mmol) of carbohydrazide for L1, 0.56 g (5 mmol) of cinnamaldehyde for L2. The mixture was stirred under reflux for 5-6 hours at 700 C. In the case of ligand 1 (L1), a dark green precipitate was obtained from which excess solvent was removed in vacuo then the ligand was isolated by column (silica gel) chromatography and by recrystallization from various solvents (like diethyl ether, ethanol, methanol, chloroform). In the case of second ligand L2, a dark brown colored product was obtained that was insoluble in the solvent, this was filtered off and then washed and recrystallized from various solvents(diethyl ether, ethanol, methanol, chloroform).

L₁: Dark green crystals; yield:64%, M.P.:130° C.; Analysis calculated for (C₃₇H₄₁N₁₃S₂): C, 68.97; H, 8.88; N, 13.98%, Found: C, 68.90; H, 8.92; N, 13.90%,; IR (KBr, cm⁻¹) ; v: 3886.07 cm⁻¹, 3812.15 cm⁻¹, 3848.89 cm⁻¹, 3256.67 cm⁻¹, 2854.70 cm⁻¹, 1623.47 cm⁻¹, 1558.89 cm⁻¹, 467.09 cm⁻¹, ¹H NMR (300 MHz, CDCl₃) δ: 8.22 (1H, s, N═CH), 6.55, 7.23 (4H, m, Ar—H), 3.14(6H, s, N—CH₃) 1.25(2H, m; —CH₂) 0.92 (3H,t,CH₃):MS, m/z Calc. for C₃₇H₄₁N₁₃S₂ −735 g/mol found 731 g/mol, Solubility: Ethanol, DMF, DMSO

L2: Dark brown crystals; yield:70%, m.pt.2000 C; Analysis calculated for (C19H19N3O2): C, 76.80; H, 7.03; N,15.16%, Found: C, 78.80; H, 7.03; N,15.20%,; IR (KBr, cm−1) ; v: 1640 cm−1(N═C), 1274 (C—N), 1196 (C—O); H1NMR (300 MHz, CDCl3) δ: 8.62 (2H, s, N═CH), 6.32-7.60(12H, m, Ar—H), MS m/z Calc. for C19H19N3O2 −322 g/mol found −321.

Solubility: Ethanol, DMF, DMSO

### 2.4 Synthesis of Chromium (III) Complexes

Chromium (III) chloride (1.58 g, mmol) was dissolved in absolute ethanol (10 ml). A two-fold ratio of the relevant Schiff base ligand (1.42 gm, 5 mmol) of L1and 1.24 gm (5 mmol) of L2 dissolved in ethanol (25 ml) was then added with constant stirring resulting in color change. The mixture was refluxed for 5-6 hours, then the excess solvent was removed in vacuo. The resultant colored solid product was filtered off, washed with cold solvents (ethanol, diethyl ether) then allowed to dry and recrystallized using a various solvent mixtures (diethyl ether, ethanol, methanol, chloroform).

CrL₁: Dark green crystals; yield: 60%, M.P.>250° C.; Analysis calculated for C₃₇H₄₁N₃S₂CrCl₃: C, 52.37; H, 7.31; N, 10.36; Cr 10.67% Found: C, 52.39; H, 7.33; N, 10.33; Cr10.70%,; IR (KBr, cm⁻¹) ; v: 1628 cm⁻¹(N═C), 1260 (C—N), 1127 (C═S),425 (Cr—N);

Solubility: Ethanol, DMF, DMSO

Molar Conductance (DMSO 25° C.) Am: 11.6 S cm² mol⁻¹

CrL₂: Dark brown crystals; yield: 59%, M.P.>300° C.; Analysis calculated for C₁₉H₁₉N₃O₂CrCl₃: C, 61.22; H, 6.01; N, 11.87, Cr 10.6% Found: C, 61.24; H, 6.00; N, 11.84; Cr, 10.8%; IR (KBr, cm⁻¹); v: 1620 cm⁻¹ (N═C), 1257 (C—N), 1175 (C—O), 450 (Cr—N);

Solubility: Ethanol, DMF, DMSO, Molar Conductance (DMSO 25° C.) ∧m: 11.8 S cm² mol⁻¹

### Antioxidant Activity Assay:

Antioxidant activity of the synthesized Cr(III) Schiff base complexes was tested using the free radical compound 2,2-diphenyl-1-picrylhydrazyl(DPPH) (25,26). This compound has a violet color when dissolved in ethanol and a strong absorption maximum centered at around 515-520 nm. DPPH became colorless or pale yellow when neutralized. An aliquot of DPPH (0.3 ml) in ethanol (0.5 mm) was added to ethanol(3 ml), followed by addition of Cr(III) complex dissolve in ethanol (0.5 ml)(total Volume 3.8 ml). A UV/visible spectrophotometer was used to monitor the color change at 517 nm after 100 minutes of reaction. A blank sample contained a mixture of the Cr(III) complex in ethanol (0.5 ml) and ethanol (3.3 ml) (Total Volume 3.8 ml) without any DPPH (no violet color). A control sample contained a solution of DPPH (0.3 ml) and ethanol (3.5 ml) (total volume 3.8 ml) without any Cr (III) complex (Violet color remains). The amount of scavenging activity (%) was determined by the method of Mensor et al. (27).

Finally, the % scavenging activities for Schiff base ligands and derived Cr(III) complexes were calculated by applying the formula

Scavenging activity=(Ac−At)/Ac×100%

Where Ac and At represent the absorbance of the control and test samples, respectively (Choudhary et al., 2011)²⁸

### 3. Results and Discussion

This research work reports the synthesis, characterization, molecular docking and in vitro antioxidant activities of Schiff base ligands and their coordinated Cr(III) complexes. All compounds were stable at room temperature and all are soluble in DMSO& DMF in all proportions. The elemental analysis of the compounds were consistent with the proposed structure of the compounds. The molar conductance values of Chromium (III) complexes were 28.9 and 19.2 ohm−1cm2mol−1 in DMF solution at room temperature confirms the formation of 1:2 electrolytic nature and indicates the non-electrolytic nature of chromium (III) complexes. Schiff base ligands and their coordination complexes with Cr (III) ions are stable under ambient conditions. All complexes were soluble in common organic solvents like DMF, DMSO, hexane. All compounds were characterized by elemental analysis, UV-Visible, FT-IR, XRD & TGA analysis. Schiff base ligands derived from Schiff base ligands (L1 & L2) were prepared in good yield (55-70%) using the refluxing method followed by the product separation. The ligands L1and L2 were isolated as colored crystals having dark green and brown color respectively. A twofold ratio of each Schiff base ligand was reacted with Cr (III) chloride, which produces a color change. The prepared Cr (III) complexes (CrL1, CrL2) were obtained in good yield (55-60%) and as crystals having color of black and brown, respectively. All Compounds showed the best solubility in organic solvent at room temperature and variable solubility in ethanol. Based on Conductance measurement in DMSO, the Cr(III) complexes are all non-electrolytes in nature. This was considered because the chromium complexes have an overall neutral charge. The isolated and crystallized Schiff base ligands and the resultant Cr (III) complexes were characterized by melting point, elemental analysis, IR spectroscopy, NMR spectroscopy, and mass spectroscopy. All synthesized compounds produced IR spectra bands consistent with those in literature spectra of similar Schiff base ligand and derived Cr(III) complexes. The disappearance of bands from amine (—NH2) and aldehyde (—CHO) groups confirmed the reaction of the starting compounds. The appearance of a peak in the region 1640-1660 cm−1 coming from an azomethine (C═N) bond, confirmed Schiff base ligand production, and this was shifted to 1620-1635 cm−1 on the production of Cr(III) complexes. This lowering in frequency indicates electron pair donation by the nitrogen atom of the Cr (III) ions. For the Cr(III) complexes there was an appearance of bands for Cr—N 450 cm−1 in the far IR region, which were not presented in spectra of the original Schiff base ligands. 1HNMR spectra of the synthesized Schiff based ligands were consistent with their expected structures including signals at 8.22 (1H, S), 8.62 (2H, S) and 8.46 ppm (1H, S) for the proton in the azomixture group of ligands L1and L2 respectively. Synthesis of the Schiff base ligands was further confirmed by mass spectrometry. All experimental evidence suggests that the general formula for the synthesized Cr (III) complexes is CrL2Cl2 in which the ligand act as tridentate.

Antioxidant activity of the synthesized Cr (III) Schiff base complexes was tested by DPPH assay, in which there was a decrease in DPPH free radical with increasing concentration of complexes. The results suggest that the Cr(III) complexes are good scavengers of free radicals species and therefore show promise for further investigation to target oxidative damage diseases. The first step of our research is the preparation of Schiff base ligands with precursors. The empirical formulas of Schiff base ligands and their coordinated Chromium complexes have been justified by FT-IR spectra and also confirmed by the analytical and spectral analysis.

### Thermal Analysis of Synthesized Compounds

Thermal Analysis of Compounds can be done by Thermogravimetric analysis TGA method. The results of the thermal analysis for ligands and their coordinated Chromium (III) complexes are given in table 2 and the thermograms are shown FIGS. 15 & 16. Coordinated Chromium (III) complexes are stable at room temperature and did not change the color in safekeeping in a dry place. The thermal decomposition of the complexes takes place in four steps. The first decomposition step, an endothermic one, in the temperature range of 800 C-1300 C is associated with all complexes to the loss of crystalline water. The second step of the thermal decomposition of the complexes corresponds to the elimination of coordinated water and takes place over a temperature range of 1400 C-2200 C, associated with an endothermic peak. For the complexes, the second step can be correlated with the ligand side group releases, phenolic groups of ligand, for complex, weight loss by the elimination of two water molecules. The next step of decomposition is a complex reaction step, being an overlap of process. The third stage of the thermal decomposition process corresponding to the loss of chloride, sulphate, and acetate ions. The last step of thermal decomposition was strongly exothermic corresponding to the oxidative degradation of the organic ligand residue. It starts from 380 to 4900 C and finishes around 7500 C for all the complexes. The final residue of decomposition is Cr—O and the chromium percentage determine from this is in accordance with the theoretical content.

TABLE 2
Thermal Decomposition data of the ligands and their coordinated Cr(III) Complexes

| | | Thermal | Temperature | | | | |
|---|---|---|---|---|---|---|---|
| Complex | Step | effect | range (° C.) | | %Δm_{exp.} | %Δm_{calc.} | Chemical Process |
| Ligand | I | Endothermic | 80-130° | C. | 1.82 | 2.10 | H₂O Loss |
| | II | Endothermic | 110-210° | C. | 3.4 | 4.32 | 2H₂O Coordinated Loss |
| | III | Exothermic | 210-360° | C. | 19.1 | 19.25 | 2HCl + 2H₂O Loss |
| | IV | Exothermic | 360-780° | C. | 65.00 | 65.66 | Oxidative degradation |
| | | | | | | | of organic residue |
| Complex 1 | I | Endothermic | 60-80° | C. | 1.94 | 2.20 | H₂O Loss |
| | II | Endothermic | 160-220° | C. | 3.9 | 4.85 | 2H₂O Coordinate Loss |
| | III | Exothermic | 230-490° | C. | 22.4 | 24.2 | Loss of chloride ions |
| | IV | Exothermic | 490-750° | C. | 54.00 | 56.00 | Oxidative degradation |
| | | | | | | | of organic residue |
| Complex 2 | I | Endothermic | 70-90° | C. | 2.12 | 2.90 | Loss of H₂O molecules |
| | II | Endothermic | 120-190° | C. | 5.20 | 5.68 | 5H₂O Loss |
| | III | Exothermic | 200-400° | C. | 24.4 | 25.2 | Loss of chloride ions |
| | IV | Exothermic | 400-790° | C. | 49.2 | 52.4 | Oxidative degradation |
| | | | | | | | of organic residue |

### Powdered XRD Analysis

The Powdered XRD technique is a very important crystallographic technique that has been used for the identification of different peaks in the powdered samples of chromium complexes. FIGS. 17 & 18 showed that XRD spectra of chromium(III) complexes. From the full width at half maximum of diffraction peaks of X-rays are employed to calculate the average crystalline size using Debye-Scherer's equation i.e.,

$$D = 0.9 \times \frac{λ}{β \cdot cos θ}$$

Where, D=Crystalline size
λ=wavelength of X-Rays
β=Full width at half maximum of the diffraction peak
θ=Bragg's angle

The particle size of the Schiff base ligands and their chromium (III) complexes were below 100 nm-200 micrometers. (Calculated by using Debye Scherer equation) and the width of the X-rays peaks are almost similar to the crystalline size of the particles of the ligands and their chromium (III) complexes. XRD pattern of ligands and their coordinated chromium (III) complexes were revealed in XRD graphs. The X-ray powder diffraction analysis of ligands and their chromium (III) complexes were carried out to give information about the atomic or molecular arrangement as shown in Fig. In spectra, sharp peaks indicating the crystalline nature of complexes. The X-ray powder diffraction patterns were attained in the range of 2-800θ values. The full width at the half-maximum (FWHM) of diffraction peaks observed from the refinement was used to evaluate the particle size also to investigate the crystalline information about chromium (III) complexes. The diffraction peaks of complexes indicate that the synthesis of chromium complexes is in the manometer range.

### TEM Morphological Studies

A transmission electronic microscope is used to view a thin film section/specimen through which electrons can pass and generating a projection image. FIGS. 21 & 22 show the TEM images of ligands and their coordinated Chromium (III) complexes respectively. The uniformity and similarity between the particle forms of synthesized ligands and their coordinated Chromium (III) complexes indicate that the existence of morphological phases has a homogenous matrix.

TABLE 3
Representative antioxidant activity of Schiff Base
ligands and coordinated Chromium (III) complexes

| | | | | DPPH | |
|---|---|---|---|---|---|
| | | | | Equivalent | Total |
| | Dilu- | Wave- | Inhi- | Antioxidant | Antioxidant |
| Compound | tion | length | bition | activity | activity |
| Ligand 1 | 1 ml | 517 | 0.077 | 1.253 | 65% |
| Ligand 2 | 1 ml | 517 | 0.074 | 1.223 | 66% |
| [Cr(L1)₂]Cl₃•H₂O | 1 ml | 517 nm | 0.145 | 3.354 | 77% |
| [Cr(L2)₂]Cl₃•H₂O | 1 ml | 517 nm | 0.118 | 2.875 | 88..2% |

Chromium has an essential role in the metabolism of protein, Lipids Carbohydrate through increasing insulin efficiency studies. Showed that Chromium supplementation markedly increased antioxidant enzyme activity and improved levels of Antioxidant indices. Paper aimed to evaluate Chromium supplementation potential roles in oxidative stress indices in diabetes mellitus.

### Conclusion

Novel two chromium (III) complexes have been prepared by template synthesis using cinnamaldehydehydrazones Schiff base ligand and appropriate chromium salts, 2:2:1 And 1:2 molar ratio. Physiochemical, analytical thermal analysis, and various spectroscopic characterization confirmed the coordination of hydrazones Schiff base ligand with Cr(III) ions in 2:2:1 & 1:2 molar ratio. All coordinated chromium (III) complexes are better scavengers of superoxide anions radical than cinnamaldehyde. This scavenging activity is mainly due to the redox reaction within the Cr3+/Cr couple and secondary to the phenolic functional group of the Cinnamaldehyde derivative hydrazones Schiff base ligand. This research work also explains the fact that the chromium complex exhibits the highest antioxidant activity, this research work did not receive any specified amount from funding agencies in the public, commercial or non-profit section.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention.

### REFERENCES

1. A. Prakash and D. Adhikari, Application of Schiff bases and their metal complexes—A Review, Int. J. ChemTech Res., 3, 1891 (2011).
2. N. Mishra, K. Poonia and D. Kumar, An overview of biological aspects of Schiff base metal complexes, Int. J. Adv. Res. Tech., 2, 52 (2013).
3. R. Kumara and R. Kant, Review on synthesis and application of Schiff base and its transition metal complexes, Res. J. Chem. Environ. Sci., 2, 1 (2014).
4. A. Kajal, S. Bala, S. Kamboj, N. Sharma and V. Saini, Schiff bases: A versatile pharmacophore, J. Catalysts, Article ID 893512 (2013). DOI:10.1155/2013/893512.
5. J. Kumar, A. Rai and V. Raj, A comprehensive review on the pharmacological activity of Schiff base containing derivatives, Org. Med. Chem., 1, 1 (2017).
6. S. Kumar, D. N. Dhar and P. N. Saxena, Applications of metal complexes of Schiff bases—A review, J. Sci. Indust. Res., 68, 181 (2009).
7. P. Anand, V. M. Patil, V. K. Sharma, R. L. Khosa and N. Masand, Schiff bases: A review on biological insights, Int. J. Drug Design. Discov.,3, 851 (2012).
8. W. A. Zoubi, Biological activities of Schiff bases and their complexes: A review of recent works, Int. J. Org. Chem., 3, 73 (2013).
9. A. Rani, M. Kumar, R. Khare and H. S. Tuli, Schiff bases as an antimicrobial agent: A review, J. Biol. Chem. Sci., 2, 62 (2015).
10. K. Divya, G. M. Pinto and A. F. Pinto, Application of metal complexes of Schiff bases as an antimicrobial drug: A review of recent works, Int. J. Curr. Pharm. Res., 9, 27 (2017).
11. Y. Zhang, B. Zou, Z. Chen, Y. Pan, H. Wang, H. Liang and X. Yi, Synthesis and antioxidant activities of novel 4-Schiff base-7-benzyloxy-coumarin derivatives, Bioorg. Med. Chem Lett. 21, 6811 (2011).
12. W. A. Zoubi, A. A. S. Al-Hamdani and M. Kaseem, Synthesis and antioxidant activities of Schiff bases and their complexes: a review, App. Organometal. Chem. 30, 810 (2016).
13. K. T. Tadele, Antioxidant activity of Schiff bases and their metal complexes: A recent review, J. Pharm. Med. Res., 3, 73 (2017).
14. K. J. Barnham, C. L. Masters and A. I. Bush, Neurodegenerative diseases and oxidative stress, Nat. Rev. Drug Discov., 3, 205 (2004).
15. B. Uttara, A. V. Singh, P. Zamboni and R. T. Mahajan, Oxidative stress and neurodegenerative diseases: a review of upstream and downstream antioxidant therapeutic options, Curr. Neuropharm.,7, 65 (2009).
16. R. K. Gupta, A. K. Patel, N. Shah, A. K. Chaudhary, U. K. Jha, U. C. Yadav, P. K. Gupta and U. Pakuwal, Oxidative stress and antioxidants in disease and cancer: a review, Asian Pac. J. Cancer Prev., 15, 4405 (2014).
17. Krejpcio, Z. (2001). Essentiality of chromium for human nutrition and health. Polish Journal of Environmental Studies10, 399-404.
18. Eastmond, D. A., MacGregor, J. T., & Slesinski, R. S. (2008). Trivalent chromium: Assessing the genotoxic risk of an essential trace element and widely used human and animal nutritional supplement Critical Reviews in Toxicology, 38, 173-190. DOI: 10.1080/10408440701845401
19 Katz, S. A., & Salem, H. (1993). The toxicology of chromium with respect to its chemical speciation: A review. Journal of Applied Toxicology, 13, 217-224. DOI: 0.1002/jat.2550130314.
20 Tian, Q. L., Liao, S. H., Lu, P., & Liu, L. J. (2006). Spectroscopic study on the interaction of Al3+ with flavonoids and BSA.Chinese Journal of Chemistry, 24, 1388-1390. DOI:10.1002/cjoc.200690259.21. Dehghan, G., & Khoshkam Z. (2012). Tin(II)-quercetincomplex:Synthesis, spectral characterization and antioxidantactivity. Food Chemistry, 131, 422-426. DOI: 10.1016/j.foodchem.2011.08.074.
22. Krejpcio, Z. (2001).Essentiality of chromium for human nutrition and health. Polish Journal of Environmental Studies, 10, 399-404.
23. Kunti\acute{ }c, V., Malešev, D., Radovi\acute{ }c, Z., & Vukojevi\acute{ }c, V. (2000). Spectrophotometric investigation of the complexing reaction between rutin and titanyloxalate anion in 50% ethanol. Monatsheftef\acute{ }urChemie/Chemical Monthly, 131, 769-777.DOI: 10.1007/s007060050024.
24. Fathiazad, F., Delazar, A., Amiri, R., & Sarker, S. D. (2006). Extraction of flavonoids and quantification of rutinfromwaste tobacco leaves. Iranian Journal of Pharmaceutical Research, 3, 222-227.
25W. Brand-Williams, M. E. Cuvelier and C. Berset, Use of a free radical method to evaluate antioxidant activity, Lebenson.Wiss.Technol, 28, 25 (1995).
26. P. Molyneux, The use of the stable free radical diphenylpicrylhydrazyl (DPPH) for estimating antioxidant activity, J. Sci. Educ. Technol., 26, 211 (2004).
27. L. L. Mensor, F. S. Menezes, G. G. Leitão, A. S. Reis, T. C. dos Santos, C. S. Coube and S. G. Leitão, Screening of Brazilian plant extracts for antioxidant activity by the use of DPPH free radical method, Phytother. Res., 15, 127 (2001).

We claim:

1. A process of preparation of synthesis of novel metal complexes from Schiff base ligands, the process comprising steps of:
preparing a schiff base ligands of a predetermined quantities of primary amines with a predetermined quantity of aldehydes thereby forming a precipitate, wherein the alcohol precipitate is adapted to crystalline structure;
preparing a solution of primary amines and Schiff base ligands in alcohol and dropping the alcoholic solution of metallic salt in the form of droplets in the solution of alcohol thereby forming a colored precipitate;
soaking the precipitate into the solution of alcohol for a predetermined time period; and
separating a precipitate using a filter and drying the precipitate for a determined time period thereby forming the crystalline precipitate of metal complexes.

2. The process as claimed in claim 1, wherein the metal complexes are stable at ambient temperature and reduce the impact of moisture on the environment and reduce the contamination of the water of crystallization.

3. The process as claimed in claim 1, wherein the compounds are soluble in nonpolar solvents according to acceptance of solubility rule thereby protecting degradation or loss of compounds in solubility process.

4. The process as claimed in claim 1, wherein the compounds are better scavengers of superoxide anion radicals than precursors.

5. The process as claimed in claim 1, wherein the precursors and metal ions are present in 2:2:1 molar ratio.
